(19) United States
(12) Patent Application Publication
(10) Pub. No.: US 2007/0068759 A1
(43) Pub. Date: Mar. 29, 2007

(54) Hydrodynamic torque converter

(76) Inventors: Bernd Koppitz, Winterbach (DE); Heinz Schultz, Hochdorf (DE)

Correspondence Address: KLAUS J. BACH, 4407 TWIN OAKS DRIVE, MURRYSVILLE, PA, 15668, US

(21) Appl. No.: 11/598,544

(22) Filed: Nov. 13, 2006

Related U.S. Application Data
(63) Continuation-in-part of application No. PCT/EP05/05077, filed on May 11, 2005.

(30) Foreign Application Priority Data
May 14, 2004 (DE) 10 2004 024 004.3

(51) Int. Cl. F16H 45/02

(52) U.S. Cl. 192/3.3; 192/70.17; 192/212

(57) ABSTRACT

In a hydrodynamic torque converter including a working fluid for the transmission of a torque from an engine to an output shaft, a pump impeller, a stator with guide vanes, a turbine wheel connected to the output shaft via a hub-like support, a converter lock-up clutch for locking the pump impeller to the turbine wheel and a torsional vibration damper connected between the turbine wheel and the output shaft and including disk-shaped support elements, annular axially and radially extending gap seals are provided between two adjacent disk-shaped support elements of the vibration damper so as to form a labyrinth seal structure for controlling the flow of fluid through the converter lock-up clutch for cooling the clutch.

This is a Continuation-In-Part Application of pending International patent Application PCT/EP2005/005077 filed May 11, 2005 and claiming the priority of German patent application 10 2004 024 004.3 filed May 14, 2004.

### BACKGROUND OF THE INVENTION

The invention relates to a hydrodynamic torque converter including an impeller, a stator and a turbine which is mounted on an output shaft and also a converter lock-up clutch for locking the turbine wheel to the impeller.

Hydrodynamic torque converters are disclosed, for example, by German Laid-Open Specifications DE 197 22 151 A1 and DE 197 58 677 A1.

All these hydrodynamic torque converters have a hydraulic working medium, in particular hydraulic oil, in a working space, a driven pump impeller, a stator, a turbine wheel connected to an output shaft, a lock-up clutch which connects the pump impeller and the turbine wheel and has at least one associated fastening flange, a torsional vibration damper which is connected between the turbine wheel and the output shaft and has two associated fastening flanges, one fastening flange of the torsional vibration damper being fixedly connected in terms of drive to one fastening flange of the converter lock-up clutch, and the other fastening flange being fixedly connected in terms of drive to the hub.

However, a disadvantage with these hydrodynamic torque converters is that, for an accurate control of the flow of the working fluid, sealing of the working space by means of a plurality of sealing elements is necessary. These sealing elements, which in this case are ring- or disk-shaped, increase the number of parts of the hydrodynamic torque converter and likewise the number of assembly steps, as a result of which the time needed for the production is increased, as are the production costs.

It is the object of the present invention to provide a hydrodynamic torque converter whose efficiency is increased and which comprises fewer individual parts.

### SUMMARY OF THE INVENTION

In a hydrodynamic torque converter including a working fluid for the transmission of a torque from an engine to an output shaft, a pump impeller, a stator with guide vanes, a turbine wheel connected to the output shaft via a hub-like support, a converter lock-up clutch for locking the pump impeller to the turbine wheel and a torsional vibration damper connected between the turbine wheel and the output shaft and including disk-shaped support elements, annular axially and radially extending gap seals are provided between two adjacent disk-shaped support elements of the vibration damper so as to form a labyrinth seal structure for controlling the flow of fluid through the converter lock-up clutch for cooling the clutch.

The labyrinth seal structure has minimum intermediate spaces forming quasi-tight gap seals between the fastening elements or flanges as a result of the particular geometric design and shape of the support elements or flanges. As a result, no further measures and no additional sealing elements, such as disks, sealing rings or Belleville spring washers, are required for the sealing of the working space, and yet, the flow resistance to undesirable secondary flows of the working medium is increased without additional sealing elements. Thus, secondary flows are throttled and the working fluid is specifically directed through the converter lock-up clutch.

Also, the assembly of the hydrodynamic torque converter is substantially simplified, because fewer parts are required and assembly steps are dispensed with or simplified, so that the assembly costs are also reduced. In addition, due to the omission of additional sealing elements, the centering of the components is simplified and the centering of the rotating parts of the hydrodynamic torque converter is improved.

Despite the double gap seal, the friction losses remain low compared with other sealing elements, so that also the efficiency of the hydrodynamic torque converter is increased.

In a preferred configuration of the device, the gap seals are formed by a region having a T-shaped portion at one fastening element and by a region bearing against the latter and having a roughly S-shaped bend at the other fastening element.

Both the T-shaped portion at the one fastening element and the roughly S-shaped bend at the other fastening element for the torsional vibration damper can be provided in a simple manner and at only a slight extra cost. This special shaping results in a double bearing area between the relevant regions of the one and the other fastening element. This leads to a noticeably improved sealing effect compared with a single, seal area, of, relative to a larger bearing area, reduced friction, because of the resulting linear contact, a factor which has a friction-reducing effect and thus improves the operating efficiency.

In an advantageous embodiment of the invention, at least one of the fastening elements of the torsional vibration damper is a disk-shaped fastening flange. Such a disk-shaped fastening flange can be produced and formed cost-effectively by simple punching from a plate, and can have various forms and designs without any problems.

Preferably, the other fastening element, which may be fixedly connected for rotation with a hub-like support of the turbine wheel of the torsional vibration damper and the output hub are integrally formed.

Due to this measure, a mechanical connection, for example a rivet, screw or weld connection, between the second fastening element of the torsional vibration damper and the output hub is unnecessary, which facilitates the assembly of the hydrodynamic torque converter and thereby reduces the use of different materials and also reduces assembly cost. Inter alia, separate balancing of the second fastening element of the torsional vibration damper and of the output hub can thus be avoided; it is sufficient to jointly balance the parts which are connected mechanically to one another. In an analogous manner, this also applies to the centering of these parts inside the hydrodynamic torque converter.

In a preferred embodiment of the invention, the torsional vibration damper has a third fastening element and this third fastening element bears sealingly against the hub-like support of the turbine wheel. This third fastening element, which can be produced in a simple and cost-effective manner and is easy to install, helps to throttle secondary flows of the working medium and thus helps to control the flow rate through the converter lock-up clutch and saves additional sealing elements in the process, such as disks, sealing rings or Belleville spring washers.

In a further embodiment of the invention, the hub-like support of the turbine wheel has a roughly L-shaped region, so as to form a seal between this L-shaped region of the hub-like support of the turbine wheel and the region of the T-shaped portion of the second fastening element of the torsional vibration damper. This seal is produced by a labyrinth-shaped double fit between the L-shaped region of the hub-like support of the turbine wheel and the region of the T-shaped portion of the second fastening element of the torsional vibration damper. This seal is formed by a labyrinth-shaped double fit between the L-shaped region of the hub-like support of the turbine wheel and the region of the T-shaped portion of the second fastening element of the torsional vibration damper.

This special shaping, with minimum bearing area, forms a quasi-tight seal or throttling in both the axial and the radial direction and therefore produces a specific flow of the working medium through the converter lock-up clutch for lubrication and in particular for cooling.

The invention will now become more readily apparent from the following description of an exemplary embodiment thereof with reference to the accompanying drawings:

### BRIEF DESCRIPTION OF THE DRAWINGS

FIG. 1 is a cross-sectional view of a hydrodynamic torque converter comprising a torsional vibration damper and a converter lock-up clutch, and

FIG. 2 shows enlarged a detail of the hydrodynamic torque converter according to FIG. 1 in the region of the hub-like support of the turbine wheel and of the drive hub.

### DESCRIPTION OF A PREFERRED EMBODIMENT

The invention is especially suitable for a hydrodynamic torque converter for installation in the drive train of a motor vehicle.

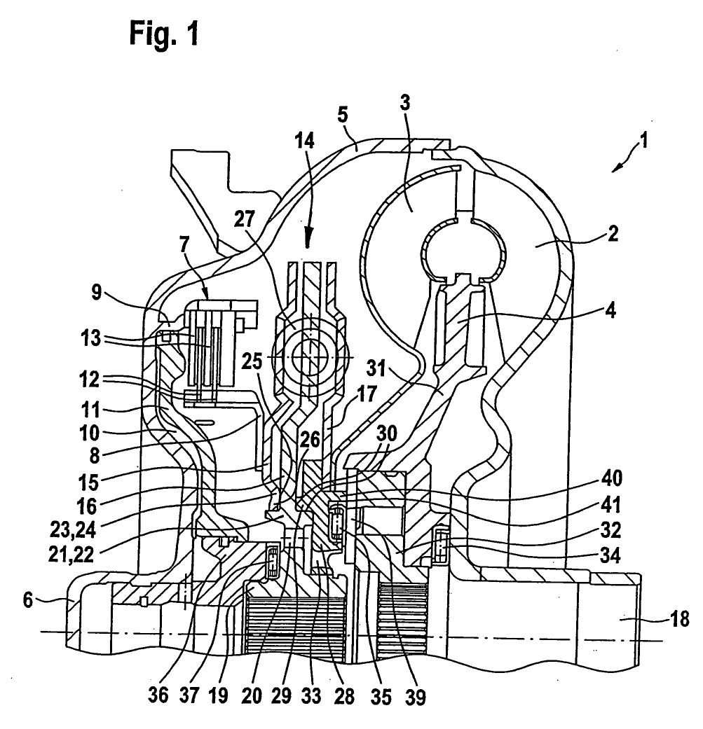

FIG. 1 is a cross-sectional view of a hydrodynamic torque converter 1. To form a hydraulic working circuit in a working space with a hydraulic working medium, generally a hydraulic oil, the torque converter 1 has a pump impeller 2, a turbine wheel 3, a stator 4 and a casing 5. The pump impeller 2 is driven by a drive shaft 6 connected to a driving engine (not shown), the casing 5 being fixedly connected in terms of drive to both the drive shaft 6 and the pump impeller 2. The stator 4 is connected via a stator carrier 31 to a free-wheel clutch 32 disposed on an output shaft 18. The stator carrier 31 is sealed off and centered relative to the casing 5 by a sealing element 34 and has a cover disk 39 for sealing relative to the working medium. The free-wheel clutch 32 is sealed off and centered relative to a hub-like support 28 for the turbine wheel 3 by a sealing element 35.

The hydraulic operating circuit can be bridged by a converter lock-up clutch 7 interlocking the pump impeller 2 and the turbine wheel 3 and having associated support elements 8, 9 (inner clutch plate carrier 8 with associated fastening flange and outer clutch plate carrier 9 with associated fastening flange), by introducing hydraulic oil under pressure into a pressure chamber 10. As a result, pressure is applied to a radial piston 11 disposed on a hub 36 so that the inner clutch plates 12 and the outer clutch plates 13 of the converter lock-up clutch 7 are pressed together. In a known manner, the inner plate carrier 8, the outer plate carrier 9, the inner plates 12 and the outer plates 13 have openings (not shown here), so that the working medium can flow through the converter lock-up clutch 7 for lubricating and in particular for cooling the clutch.

In order to dampen shocks in the drive train during load changes, starting and gear-shifting actions, a known torsional vibration damper 14 of a spring/mass system type having an associated (outer) first fastening element 15, and associated (central) second fastening element 16 and an associated (outer) third fastening element 17 is connected between the turbine wheel 3 and the output shaft 18. The fastening elements 15, 16 and 17 are disk-shaped fastening flanges, the (outer) first fastening element 15 and the (outer) third fastening element 17 of the torsional vibration damper 14 being rotatably mounted relative to the (central) second fastening element 16 against the force of pre-loaded springs 27.

The (central) second fastening element 16 is expediently formed in one piece with an output hub 19, supported on the output shaft 18 in a rotationally fixed manner and has in the vicinity of the output hub 19 openings 20, through which the working fluid flows. The first fastening element 15 is fixedly connected for rotation with the fastening element 8 (inner plate carrier) of the converter lock-up clutch 7. The (outer) third fastening element 17 of the torsional vibration damper 14 is fixedly connected for rotation with the hub-like support 28 for the turbine impeller 3 and bears against it in a sealing manner. The hub-like support 28 in turn is fixedly connected for rotation with the output hub 19, for example by means of a spline system. The turbine wheel 3 is also fixedly connected for rotation with the output hub 19 likewise via the hub-like support 28. The output hub 19 is sealed off relative to the hub 36 by a sealing element 37.

In a region 21, the second fastening element 16 of the torsional vibration damper 14 has a T-shaped portion 22. A region 23 of the first fastening element 15 having an S-shaped bend 24 bears against the one side of this T-shaped portion 22 of the second fastening element 16 in such a way that two gap seals 25, 26 are formed between these two regions 21 and 23 for the control of the flow of the working fluid. The one gap seal 25 is radially oriented and the second gap seal 26 extends in the axial direction.

The hub-like support 28 for the turbine wheel 3 has a stepped region 29. As a further measure for improved, control of the flow of the working medium through the converter lock-up clutch 7 and for throttling disturbing secondary flows, a seal 30 is arranged between this stepped region 29 and the region 21 of the T-shaped portion 22 of the second fastening element 16 of the torsional vibration damper 14. This seal 30 is a labyrinth seal formed by a double fit between the stepped region 29 of the hub-like support 28 for the turbine wheel 3 and the region 21 of the T-shaped portion 22 of the second fastening element 16 of the torsional vibration damper 14.

Furthermore, the stepped region 29 of the hub-like support 28 has an extension 40 roughly rectangular in cross section. As a further sealing element, a gap seal 41 extending in the radial direction is formed between this extension 40 and the cover disk 39 of the stator carrier 31, this gap seal 41 serving to throttle disturbing secondary flows of the working medium, as do other measures already described. Furthermore, for the desired control of the flow of the working medium, the hub-like support 28 for the turbine wheel 3 has openings 33 for the working fluid to flow through.

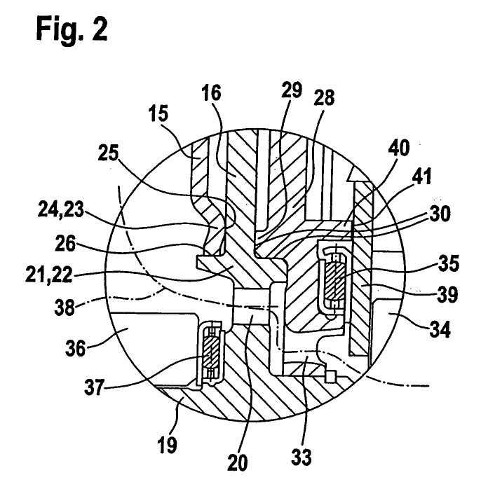

A detail of the region from FIG. 1 of the hub-like support 28 of the turbine wheel 3 and of the output hub 19 is shown enlarged in FIG. 2. A broken line 38 is intended to indicate the desired flow path, brought about by the measures described, of the working medium through the converter lock-up clutch 7, via the openings 20 and the openings 33, the flow of the working medium being possible in either direction.

These measures for controlling the flow of the working fluid through the converter lock-up clutch 7 (FIG. 1) consist in particular of the T-shaped portion 22 in the region 21 of the second fastening element 16 of the torsional vibration damper 14, of the S-shaped bend 24, bearing against the latter on the one side, in the region 23 of the first fastening element 15, and of the stepped region 29, bearing against said torsional vibration damper 14 on the other side, of the hub-like support 28 for the stator carrier 31 or, respectively, the third fastening element 17 of the torsional vibration damper 14.

What is claimed is:

1. A hydrodynamic torque converter (1) having a working fluid for the transmission of torque from an engine to an output shaft (18), said torque converter comprising a driven pump impeller (2), a stator (4), a turbine wheel (3) which is connected to the output shaft (18) via a hub-like support (28) and via an output hub (19), a converter lock-up clutch (7) for interlocking the pump impeller (2) and the turbine wheel (3), said lock-up clutch (7) including associated fastening elements (8, 9), and a torsional vibration damper (14) which is connected between the turbine wheel (3) and the output shaft (18) and has a plurality of associated support elements (15, 16, 17), a first support element (15) of the of the torsional vibration damper (14) being mounted for rotation with a fastening element (8) of the lock-up clutch (7) and a second support element (16) of the torsional vibration damper (15) being connected for rotation with the output hub (19), and the first support element (15) and the second support element (16) of the torsional vibration damper (14) being provided with a gap seal (26) extending in the axial direction and a gap seal (25) extending in the radial direction for controlling the flow of the working fluid through the converter lock-up clutch (7).

2. The hydrodynamic torque converter as claimed in claim 1, wherein the gap seals (25, 26) are formed by a T-shaped portion (22) at the second support element (16) bearing against the latter and having a roughly S-shaped bend (24) adjacent the first support element (15).

3. The hydrodynamic torque converter as claimed in claim 1, wherein at least one of the support elements (15, 16, 17) of the torsional vibration damper (14) is a disk-shaped flange.

4. The hydrodynamic torque converter as claimed in claim 1, wherein the second support element (16) of the torsional vibration damper (14) and the output hub (19) are designed as a single piece.

5. The hydrodynamic torque converter as claimed in claim 1, wherein one of the second support element (16) of the torsional vibration damper (14) and the output hub (19) has openings (20) forming flow passages for the working fluid.

6. The hydrodynamic torque converter as claimed in claim 1, wherein the hub-like support (28) for the turbine wheel (3) has flow openings (33) for the working fluid.

7. The hydrodynamic torque converter as claimed in claim 1, wherein the torsional vibration damper (14) has a third support element (17) which sealingly bears against the hub-like support (28) for the turbine wheel (3).

8. The hydrodynamic torque converter as claimed in claim 1, wherein the hub-like support (28) for the turbine wheel (3) has a roughly stepped region (29).

9. The hydrodynamic torque converter as claimed in claim 8, wherein a seal (30) is formed between the roughly stepped region (29) of the hub-like support (28) for the turbine wheel (3) and the region (21) of the T-shaped portion (22) of the second support element (16) of the torsional vibration damper (14).

10. The hydrodynamic torque converter as claimed in claim 9, wherein the seal (30) comprises a labyrinth-type double fit between the roughly stepped region (29) of the hub-like support (28) for the turbine wheel (3) and the region (21) of the T-shaped portion (22) of the second support element (16) of the torsional vibration damper (14).
